(19) United States
(12) Patent Application Publication
(10) Pub. No.: US 2004/0194816 A1
(43) Pub. Date: Oct. 7, 2004

(54) Apparatus for supplying a car wash with chemical additives

(76) Inventors: Robert Auer, Stadtbergen (DE); Georg Wimmer, Affing (DE)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/758,947

(22) Filed: Jan. 15, 2004

Related U.S. Application Data
(63) Continuation of application No. PCT/EP02/06006, filed on May 31, 2002.

(30) Foreign Application Priority Data
Jul. 25, 2001 (DE) 201 12 273.1

(51) Int. Cl. B08B 3/00

(52) U.S. Cl. 134/99.2; 134/100.1; 134/123

(57) ABSTRACT

Apparatus for supplying a car wash installation with chemical additives which are admixed with the wash water, wherein at least one additive is poured into a cartridge in highly concentrated form. An associated holding device of the car wash receives the cartridge, wherein the additive of the cartridge can be removed continuously, according to need. Several additives are poured into several cartridges in highly concentrated form and each cartridge and each associated holding device differs from the other cartridges and associated holding devices, by a mistake-proof flange-mounting.

### RELATED APPLICATION

This application is a continuation of International Application PCT/EP02/06006, filed May 31, 2002, the contents of which are here incorporated by reference in their entirety.

### BACKGROUND OF THE INVENTION

1. Field of the Invention

The invention relates to an apparatus for supplying a car wash with chemical additives.

2. Prior Art

From the state of the art, the supply of a car wash with the most varied chemical additives, for example, shampoos, drying aids, wax, and cleaners for car wheel rims, is known in that these additives are poured into large canisters from which the wash installation suctions off the additives, according to need, via hoses introduced into these canisters. The handling of these canisters is extremely cumbersome, energy-consuming, and sensitive to spray.

If the operator of a wash installation wants to fill up the shampoo, the drying aid, the wax, or the cleaner for car wheel rims, he must first open up the housing in which the corresponding canister is located, and remove the canister or canisters, which is often difficult because of the weight of the canister and its unmanageability. Then, he must open the canister fastening and remove the suction hose, which already leads to the spraying around of the wash water and additive. In this way, the housing is soiled and its surface is, to some extent, even corrosively attacked. Afterwards, the operator must pour in the additive either in already diluted form or in concentrated form and fill up with water. Under certain circumstances, this forms foams, particularly with shampoo, which delays the filling process considerably. Furthermore, there is the danger of the overflowing of additives from the canister, wherein, once more, the housing is soiled. Finally, the canister must again be placed in the housing; the suction hose must be introduced and the housing closed.

These known modes of supply for car washes have, moreover, the disadvantage of a considerable storage maintenance, since the undiluted or only slightly prediluted additives must be stored at the car wash installation in the meantime.

The problem, therefore, is to further develop an apparatus for supplying a car wash with chemical additives so that a simple, energy-saving, and quick replenishing of the additives is made possible and so there are only low storage maintenance costs.

### SUMMARY OF THE INVENTION

This problem is solved with the novel apparatus of the present invention. More particularly, an apparatus is provided for supplying a car wash installation with chemical additives which are admixed with the wash water, wherein at least one additive is poured into a cartridge in highly concentrated form, which can be placed in a holding device of the car wash, wherein the additive of the cartridge can be removed continuously, according to need, characterized in that several additives are poured into several cartridges in highly concentrated form and each cartridge and each holding device differs from the other cartridges, so that a mistake-proof flange-mounting is produced. Further, the cartridge has a snap closure, which can be inserted in a corresponding snap closure of the car wash installation and locked with it. Each cartridge has several containers to hold different additives, which can be supplied to various inlets of the car wash installation via the holding device.

The additives comprise shampoo, prewash aids, drying aids, wax, and cleaners for car wheel rims, and the car wash installations provide a connecting or metering device for the dilution of the additives or of each additive, in accordance with the application. In one embodiment, at least one additive is present as a solid, and the holding device has a rubbing device to rub out the solid. In another embodiment, at least one additive is present in powder or tablet form, and the car wash installation has a dissolving container for the dissolution of the powdery or tablet-shaped additive and the simultaneous or subsequent dilution. In still another embodiment the additive is present in a highly concentrated liquid or pasty form, and the car wash installation has at least one dissolving container for the dissolution of the liquid or pasty additive and the simultaneous or subsequent dilution.

Some embodiment examples of the invention are described in more detail below.

In all embodiment examples, the additive, which is, for example, a shampoo, a drying aid, wax, or a cleaner for car wheel rims, or a combination of these additives, is poured in highly concentrated form into a cartridge. This cartridge is placed in a holding device of the car wash, wherein the additive of the cartridge can be removed continuously according to need.

The underlying principle of all embodiment examples of the invention thus consists in using highly concentrated additives, which can be present in solid, pasty, liquid, or pulverized form. In particular, the additives can also be present in tablet form.

As a result of the fact that the additives are encapsulated in the cartridge and the cartridge can be inserted into a snap closure of the car wash, the troublesome and time-consuming replenishing is omitted. Rather, only the cartridge with the concentrated additive is replaced.

In a preferred embodiment, a specific cartridge is provided for each additive, which can be inserted into its own holding device at the car wash. By an appropriate shaping of the individual cartridges and holding devices of the car wash, a mix-up of the additives can be reliably ruled out. Moreover, it is also possible that each cartridge contains not only one additive, but rather several additives in several separate containers within the cartridge, which can be supplied to various inlets of the car wash via the holding device.

In order for the car wash installation to dilute the additive or the additives, in accordance with application, the car wash preferably has a diluting apparatus for the additives. It can, for example, be a bowl with a stirrer into which the additive is introduced and is diluted with water therein. The diluting apparatus can also be a mixing or whirling chamber into which the additive is introduced and in which it is diluted with water.

In an advantageous embodiment of the invention, the additive is present as a solid, for example, as a pressed powder, within the cartridge. In this case, the holding device can have a rubbing device to rub out the solid with the aid of a blade or a scraper.

If the additive is present in powder or tablet form in an alternative embodiment, it is directly poured into the metering device of the car wash, so as to be diluted there with water, until the concentration in accordance with the application is reached.

Should the additive be present in a highly concentrated, liquid or pasty form, the car wash installation can also have a dissolution container to dissolve the liquid or pasty additive for the dilution in accordance with the application.

### BRIEF DESCRIPTION OF THE DRAWINGS

FIG. 1 shows schematically a front view of a car washing facility.

FIG. 2 shows a portion of FIG. 1 schematically of a supply unit and three cartouches for different substances with different connections to the supply unit.

### DETAILED DESCRIPTION OF PREFERRED EMBODIMENTS OF THE INVENTION

Some embodiment examples of the invention are described in more detail below.

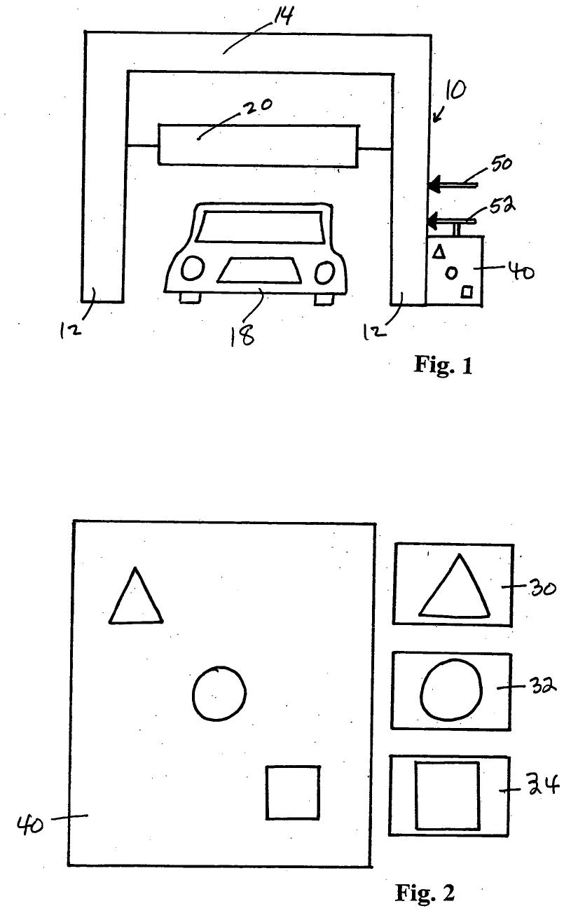

In all embodiment examples, the additive, which is, for example, a shampoo, a drying aid, wax, or a cleaner for car wheel rims, or a combination of these additives, is poured in highly concentrated form into a cartridge. This cartridge is placed in a holding device of the car wash, wherein the additive of the cartridge can be removed continuously according to need. Such an arrangement is shown in FIGS. 1 and 2. As shown, a car washing facility consists of a frame 10 on which is mounted at least one horizontal brush 20 for controlled vertical movement, and possibly other brushes are mounted on the frame 10. The frame is U-shaped and the legs 12 and cross bar 14 are provided with the requisite piping or tubing to conduct liquids containing additives or just water to sprayers mounted on the frame 10 in conventional fashion. A car 18 is shown positioned within the frame 10. Arrow 50 represents electrical supply to the car wash and arrow 52 represents water supply to the car wash and holder 40.

The underlying principle of all embodiment examples of the invention thus consists in using highly concentrated additives, which can be present in solid, pasty, liquid, or pulverized form. In particular, the additives can also be present in tablet form. The additives are contained in cartridges or containers, bearing cartouches that are distinctive from a graphics or image standpoint, so that they are easily seen and identified regarding what their contents are. As shown in FIGS. 1 and 2, the images of a triangle, circle and a square are used on containers 30, 32, 34 to distinguish them as to what additive is contained within. The containers 30, 32, 34 are inserted into a holding device 40 that is hydraulically coupled to the leg 12 of the frame 10 to feed the contents of each of the containers into the piping system of the washer under the control of a controller as is conventional and known for car washers.

As a result of the fact that the additives are encapsulated in the cartridges and the cartridges can be inserted into a snap closure of the holder 40 of the car wash, the troublesome and time-consuming replenishing is omitted. Rather, only the cartridge with the concentrated additive is replaced.

In a preferred embodiment, a specific cartridge is provided for each additive, which can be inserted into its own holding device at the car wash. By an appropriate shaping of the individual cartridges and holding devices of the car wash, i.e. geometrical configuring, a mix-up of the additives can be reliably ruled out. Moreover, it is also possible that each cartridge contains not only one additive, but rather several additives in several separate containers within the cartridge, which can be supplied to various inlets of the car wash via the holding device.

In order for the car wash installation to dilute the additive or the additives, in accordance with application, the car wash preferably has a diluting apparatus for the additives. It can, for example, be a bowl with a stirrer into which the additive is introduced and is diluted with water therein. The diluting apparatus can also be a mixing or whirling chamber into which the additive is introduced and in which it is diluted with water.

In an advantageous embodiment of the invention, the additive is present as a solid, for example, as a pressed powder, within the cartridge. In this case, the holding device can have a rubbing device to rub out the solid with the aid of a blade or a scraper.

If the additive is present in powder or tablet form in an alternative embodiment, it is directly poured into the metering device of the car wash, so as to be diluted there with water, until the concentration in accordance with the application is reached.

Should the additive be present in a highly concentrated, liquid or pasty form, the car wash installation can also have a dissolution container to dissolve the liquid or pasty additive for the dilution in accordance with the application.

What is claimed is:

1. In apparatus for supplying a car wash installation with chemical additives which are admixed with the wash water, wherein at least one additive is poured into a cartridge in highly concentrated form, an associated holding device of the car wash for receiving the cartridge, wherein the additive of the cartridge can be removed continuously, according to need, the improvement wherein several additives are poured into several cartridges in highly concentrated form and each cartridge and each associated holding device differs from the other cartridges and associated holding devices, by a mistake-proof flange-mounting.

2. Apparatus according to claim 1, wherein the cartridge has a snap closure, which can be inserted in a corresponding snap closure of the car wash installation and locked with it.

3. Apparatus according claim 1, wherein each cartridge has several containers to hold different additives, which can be supplied to various inlets of the car wash installation via the associated holding device.

4. Apparatus according to claim 1 wherein the additives comprise shampoo, prewash aids, drying aids, wax, and cleaners for car wheel rims.

5. Apparatus according to claim 1 wherein the car wash installations provide a connecting or metering device for the dilution of the additives or of each additive, in accordance with the application.

6. Apparatus according to claim 1 wherein at least one additive is present as a solid.

7. Apparatus according to claim 6, wherein the holding device has a rubbing device to rub out the solid.

8. Apparatus according to claim 1 wherein at least one additive is present in powder or tablet form.

9. Apparatus according to claim 8, wherein the car wash installation has a dissolving container for the dissolution of the powdery or tablet-shaped additive and the simultaneous or subsequent dilution.

10. Apparatus according to claim 1 wherein the additive is present in a highly concentrated liquid or pasty form.

11. Apparatus according to claim 10, wherein the car wash installation has at least one dissolving container for the dissolution of the liquid or pasty additive and the simultaneous or subsequent dilution.
